(19) United States
(12) Patent Application Publication
(10) Pub. No.: US 2008/0133879 A1
(43) Pub. Date: Jun. 5, 2008

(54) SIMD parallel processor with SIMD/SISD/row/column operation modes

(75) Inventors: Yil Suk Yang, Daejeon (KR); Tae Moon Roh, Daejeon (KR); Dae Woo Lee, Daejeon (KR); Jong Dae Kim, Daejeon (KR); Chun Gi Lyuh, Daejeon (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Electronics and Telecommunications Research Institute

(21) Appl. No.: 11/906,381

(22) Filed: Oct. 1, 2007

(30) Foreign Application Priority Data
Dec. 5, 2006 (KR) 2006-122518
Jun. 4, 2007 (KR) 2007-54309

(51) Int. Cl. G06F 9/30

(52) U.S. Cl. 712/11; 712/E09.023

(57) ABSTRACT

Provided is a single instruction multiple data (SIMD) parallel processor including a plurality of processing units connected to one another. Each processing unit includes: an instruction register; an instruction decoder; a register files selection circuit; and register files. The SIMD parallel processor can selectively control data of register files required for any one of SIMD, single instruction single data (SISD), row, and column operations in response to an instruction. Since each of the SIMD, SISD, row, and column operations can be effectively performed according to the type of application, the SIMD parallel processor has excellent utility, efficiency, and flexibility.

### CROSS-REFERENCE TO RELATED APPLICATION

This application claims priority to and the benefit of Korean Patent Application No. 2006-0122518, filed Dec. 5, 2006, and No. 2007-0054309, filed Jun. 4, 2007, the disclosure of which is incorporated herein by reference in its entirety.

### BACKGROUND

1. Field of the Invention

The present invention relates to an SIMD parallel processor with SIMD/SISD/row/column operation modes.

This work was supported by the IT R&D program of Ministry of Information and Communication/Institute for Information Technology Advancement [2006-S-006-01, Components/Module technology for Ubiquitous Terminals.]

2. Discussion of Related Art

A processor (MPU/MCU/DSP) is an essential block that fetches, decodes and executes instructions, processes signals, and reads and writes the processed signals. A typical processor has a single instruction single data (SISD) structure that sequentially processes single data in response to a single instruction.

Recently, parallel processors, for example, a single instruction multiple data (SIMD) processor and a multiple instruction multiple data (MIMD) processor, have been widely used to improve performance. The SIMD processor functions to process multiple data in response to a single instruction, while the MIMD processor functions to process multiple data in response to multiple instructions.

FIG. 1 is a block diagram of a conventional SIMD parallel processor.

Referring to FIG. 1, the conventional SIMD parallel processor includes N×M processing units PU that are all connected to a single instruction bus. The conventional SIMD parallel processor can operate and process different data in response to a single instruction to improve performance. However, since the conventional SIMD parallel processor can always perform only SIMD operations, the conventional SIMD parallel processor precludes effective and flexible applications of its hardware to various fields in which data cannot be processed in parallel.

FIG. 2 is a block diagram of a processing unit of the conventional SIMD parallel processor shown in FIG. 1. Each processing unit of the conventional SIMD parallel processor includes an instruction register, an instruction decoder, a load/store unit (LSU), register files, and function units. In the processing unit, the instruction decoder decodes an instruction and transmits control signals to the LSU, the register files, and the function units to process data.

As described above, the conventional SIMD parallel processor can process a greater amount of data in parallel than a sequential SISD processor. However, the conventional SIMD parallel processor requires a larger quantity of hardware and has poor utility, efficiency, and flexibility due to unused hardware.

### SUMMARY OF THE INVENTION

The present invention is directed to a single instruction multiple data (SIMD) parallel processor with SIMD/SISD/row/column operation modes, which can selectively control data stored in register files required for each of SIMD, SISD, row, and column operations in response to an instruction according to application fields in order to improve utility, efficiency, and flexibility.

According to an aspect of the present invention, there is provided an SIMD parallel processor including a plurality of processing units connected to one another. Each processing unit includes: an instruction register for storing an instruction input through an instruction bus; an instruction decoder for decoding the instruction stored in the instruction register to generate a control signal for selecting any one of an SIMD operation, a single instruction single data (SISD) operation, a row operation, and a column operation in response to the decoded instruction; a register files selection circuit for enabling a register file corresponding to the control signal to control the transmission of data of the enabled register file to an internal output bus of the enabled register file; a function unit for processing the data transmitted through the internal output bus in response to the control signal; and a load/store unit (LSU) for controlling the transmission of data between the register file and an external device connected to a data bus in response to the control signal.

The register files selection circuit may receive a source 1 enable input signal and a source 2 enable input signal from the instruction decoder, generate a source 1 enable output signal and a source 2 enable output signal of a register file designated by the received source 1 and 2 enable input signals, and control data transmitted to internal output buses of the designated register file in response to the generated source 1 and 2 enable output signals.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 is a block diagram of a conventional SIMD parallel processor;

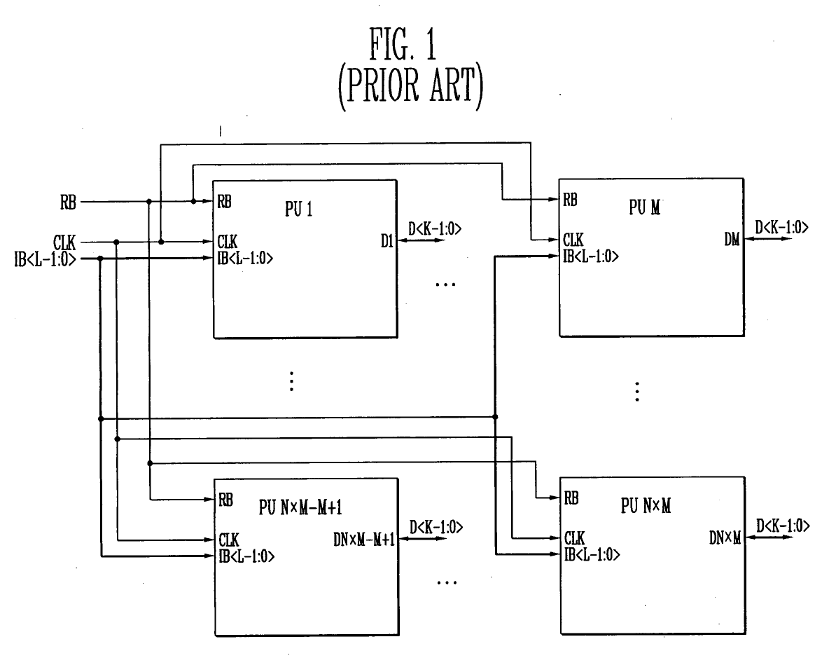

FIG. 2 is a block diagram of a processing unit (PU) of the conventional SIMD parallel processor shown in FIG. 1;

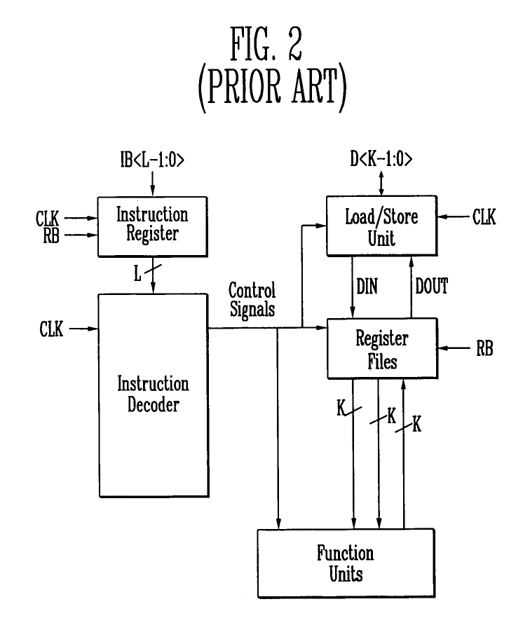

FIG. 3 is a block diagram of an SIMD parallel processor with SIMD/SISD/row/column operation modes according to an exemplary embodiment of the present invention; and

FIG. 4 is a block diagram of a processing unit (PU) of the SIMD parallel processor with SIMD/SISD/row/column operation modes shown in FIG. 3.

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to one skilled in the art.

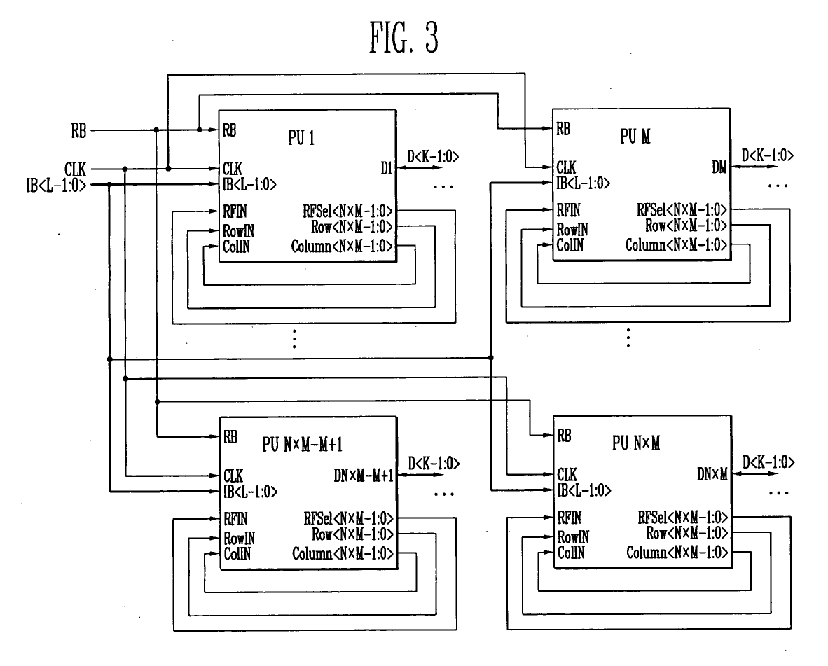

FIG. 3 is a block diagram of an SIMD parallel processor with SfMD/SISD/row/column operation modes according to an exemplary embodiment of the present invention.

Referring to FIG. 3, reference characters PU 1, . . . , PU M, . . . , PU N×M−M+1, . . . , PU N×M denote a plurality of processing units (PUs). Reference character IB<L-1:0> denotes an L-bit instruction bus connected to each PU, and D<K-1:0> denotes a K-bit data bus connected to each PU. Also, reference character RB denotes a reset signal, CLK denotes a clock signal, RFsel<N×M-1:0> denotes register files selection output signals, RFIN denotes a register files selection input signal, Row<N×M-1:0> denotes row operation selection output signals, RowIN denotes a row operation enable input signal, Column<N×M-1:0> denotes column operation selection output signals, and ColIN denotes a column operation enable input signal.

Referring to FIG. 3, an SIMD parallel processor according to the present invention includes an N×M array of PUs. Here, N and M are each an arbitrary number.

Each PU has ports for a reset signal RB, a clock signal CLK, an L-bit instruction bus IB<L-1:0>, a K-bit data bus D<K-1:0>, register files selection output signals RFsel<N×M-1:0>, a register files selection input signal RFIN, row operation selection output signals Row<N×M-1:0>, a row operation enable input signal RowIN, column operation selection output signals Column<N×M-1:0>, and a column operation enable input signal ColIN. Here, the reset signal RB, the clock signal CLK, and an instruction of the L-bit instruction bus IB<L-1:0> are input signals, while data of the K-bit data bus D<K-1:0> are input and output signals.

In the SIMD parallel processor according to the embodiment of the present invention, the reset signal RB, the clock signal CLK, the instruction of the L-bit instruction bus IB<L-1:0>, the data of the K-bit data bus D<K-1:0>, N×M-1 register files selection output signals RFsel<N×M-1:0>, the row operation selection output signals Row<N×M-1:0>, the column operation selection output signals Column<N×M-1:0>, the register files selection input signal RFIN, the row operation enable input signal RowIN, and the column operation enable input signal ColIN are organically connected a plurality of PUs.

The reset signal RB is used to initialize an initial register value and input to all the PUs of the SIMD parallel processor.

The clock signal CLK is a main clock signal of the SIMD parallel processor, and every operation of the SIMD parallel processor is synchronized with the clock signal CLK.

The single L-bit instruction bus IB<L-1:0> is connected to all the PUs of the SIMD parallel processor. The K-bit data bus D<K-1:0> is connected to all the PUs of the SIMD parallel processor and transmits input and output signals to read data from the respective PUs or write data in the respective PUs. In the embodiment, it is assumed that the L-bit instruction bus IB<L-1:0> or the K-bit data bus D<K-1:0> includes signals transmitted via a bus.

The N×M number of register files selection output signals RFSel<N×M-1:0> and the register files selection input signal RFIN are control signals used to control respective register files and data included in the SfMD parallel processor.

An N×M number of row operation selection output signals Row<N×M-1:0> and the row operation enable input signal RowIN are control signals that enable the SIMD parallel processor to operate in a row direction.

An N×M number of column selection output signals Column<N×M-1:0> and the column operation enable input signal ColIN are control signals that enable the SIMD parallel processor to operate in a column direction.

In the embodiment of the present invention, the SIMD parallel processor generates the N×M number of register files selection output signals RFSel<N×M-1:0>, the N×M number of row operation selection output signals Row<N×M-1:0>, the N×M number of column operation selection output signals Column<N×M-1:0>, the register files selection input signal RFIN, the row operation enable input signal RowIN, and column operation enable input signal ColIN in response to instructions, and the N×M number of PUs, which are organically connected to one another, perform any one of SIMD, SISD, row, and column operations in response to the generated signals.

The SIMD operation includes enabling register files of a PU designated by an instruction and transmitting data of the designated register files to an input bus of a function unit mounted on the designated PU irrespective of the register files selection output signals RFSel<N×M-1:0>, the row operation selection output signals Row<N×M-1:0>, the column operation selection output signals Column<N×M-1:0>, the register file selection input signal RFIN, the row operation enable input signal RowIN, and the column operation enable input signal ColIN.

The SISD operation includes disabling register files of an undesignated PU in response to the register files selection output signals RFSel<N×M-1:0> and the register file selection input signal RFIN, not transmitting data to an input bus of a function unit mounted on the undesignated PU, enabling only register files of a designated PU in response to the register file selection output signals RFSel<N×M-1:0> and the register files selection input signal RFIN, and transmitting data of the enabled register files to an input bus of a function unit mounted on the designated PU.

The row operation, which is a row-direction SIMD operation, includes disabling register files of an undesignated PU arranged in a row direction in response to the row operation selection output signals Row<N×M-1:0> and the row operation enable input signal RowIN, not transmitting data to an input bus of the undesignated PU arranged in the row direction, enabling only register files of a designated PU arranged in the row direction in response to the row operation selection output signals Row<N×M-1:0> and the row operation enable input signal RowIN, and transmitting data of the enabled register files to an input bus of the designated PU arranged in the row direction.

The column operation, which is a column-direction SIMD operation, includes disabling register files of an undesignated PU arranged in a column direction in response to the column operation selection output signals Column<N×M-1:0> and the column operation enable input signal ColIN, not transmitting data to an input bus of a function unit of the undesignated PU arranged in the column direction, enabling only register files of a designated PU arranged in the column direction in response to the column operation selection output signals Column<N×M-1:0> and the column operation enable input signal ColIN, and transmitting data of the enabled register files to an input bus of the function unit of the designated PU.

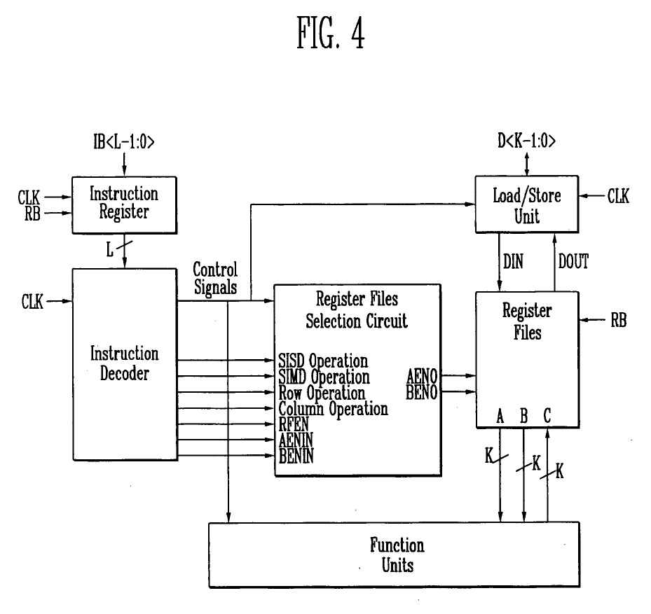

FIG. 4 is a block diagram of a PU of the SIMD parallel processor with SIMD/SISD/row/column operation modes shown in FIG. 3.

Referring to FIG. 4, the PU includes an instruction register, an instruction decoder, a load/store unit (LSU), a register files selection circuit, register files, and function units, which are electrically connected to one another.

The instruction register receives a reset signal RB and a clock signal CLK and is connected to the L-bit instruction bus IB<L-1:0>. The instruction register receives instructions from the L-bit instruction bus IB<L-1:0> and stores the instructions.

The instruction decoder is connected to the instruction register through the L-bit instruction bus IB<L-1:0>. The instruction decoder operates in synchronization with the clock signal CLK, decodes the instructions, generates control signals, and transmits the generated control signals to the LSU, the register files selection circuit, the register files, and the function units. In particular, the instruction decoder generates control signals for performing any one of SIMD, SISD, row, and column operations and transmits the generated control signals to the register files selection circuit.

The register files selection circuit receives the control signals for performing any one of the SIMD, SISD, row, and column operations, a source 1 enable input signal AENIN, and a source 2 enable input signal BENIN from the instruction decoder, generates a source 1 enable output signal AENO and a source 2 enable output signal BENO of a register file required for each of the SIMD, SISD, row, and column operations, and controls data transmitted to two internal output buses A and B of a predesignated register file using the generated output signals. When both the source 1 and 2 enable output signals AENO and BENO are at a high level, the data is transmitted to the two internal output buses A and B of the register file. When both the source 1 and 2 enable output signals AENO and BENO are at a low level, the data is not transmitted to the two internal output buses A and B of the register file.

The LSU operates in synchronization with the clock signal CLK and controls the transmission of data between the K-bit data bus D<K-1:0> connected to an external memory or an external device and register files in response to the control signal of the instruction decoder.

The register files may be initialized in response to the reset signal RB. The register files are connected to the function units through the internal output buses A and B and an internal input bus C.

The function units serve to process data stored in the register files. The function units may include an adder, a multiplier, and a shifter.

In the SIMD operation, the SIMD parallel processor maintains the source 1 and 2 enable output signals AENO and BENO of the register files of each of the PUs designated by the instruction at a high level without any conditions, so that data of the register files of the respective designated PUs can be simultaneously transmitted to the two internal output buses A and B of the register files of the respective PUs.

In the SISD operation, the SIMD parallel processor maintains the source 1 and 2 enable output signals A and B of the register files of the PU undesignated by the instruction at a low level and maintains the source 1 and 2 enable output signals A and B of the register files of the PU designated by the instruction at a high level, so that data of the register files of the designated PU can be sequentially transmitted to the two internal output buses A and B of the register files of the designated PU.

In the row operation, the SIMD parallel processor maintains the source 1 and 2 enable output signals AENO and BENO of the register file of the PU, which is arranged in the row direction and undesignated by the instruction, at a low level and maintains the source 1 and 2 enable output signals AENO and BENO of the register files of the PU, which is arranged in the row direction and designated by the instruction, at a high level, so that data of the register files of the designated PU arranged in the row direction can be transmitted to the two internal output buses A and B of the register files of the designated PU arranged in the row direction to enable a partial SIMD operation.

In the column operation, the SIMD parallel processor maintains the source 1 and 2 enable output signals AENO and BENO of the register files of the PU, which is undesignated by the instruction and arranged in the column direction, at a low level and maintains the source 1 and 2 enable output signals AENO and BENO of the register files of the PU, which is designated by the instruction and arranged in the column direction, so that data of the register files of the designated PU arranged in the column direction can be transmitted to the two internal output buses A and B of the register files of the designated PU arranged in the column direction to enable a partial SIMD operation.

As explained thus far, the present invention provides an SIMD parallel processor, which can selectively control data of register files required for any one of SIMD, SISD, row, and column operations in response to an instruction. Also, since each of the SIMD, SISD, row, and column operations can be performed according to the type of application, instruction level parallelism can be effectively applied in various fields. Therefore, SIMD parallel processors with high utility, efficiency, and flexibility can be fabricated.

The drawings and specification above disclose typical exemplary embodiments of the invention and, although specific terms are employed, they are used in a generic and descriptive sense only and not for purposes of limitation. It will be understood by those of ordinary skill in the art that various changes in form and details may be made to the above exemplary embodiments without departing from the spirit and scope of the present invention defined by the following claims.

What is claimed is:

1. A single instruction multiple data (SIMD) parallel processor comprising a plurality of processing units connected to one another,
wherein each processing unit comprises:
an instruction register for storing an instruction input through an instruction bus;
an instruction decoder for decoding the instruction stored in the instruction register to generate a control signal for selecting any one of an SIMD operation, a single instruction single data (SISD) operation, a row operation, and a column operation in response to the decoded instruction;
a register files selection circuit for enabling a register file corresponding to the control signal to control the transmission of data of the enabled register file to an internal output bus of the enabled register file;
a function unit for processing the data transmitted through the internal output bus in response to the control signal; and
a load/store unit (LSU) for controlling the transmission of data between the register file and an external device connected to a data bus in response to the control signal.

2. The SIMD parallel processor according to claim 1, wherein the register files selection circuit receives a source 1 enable input signal and a source 2 enable input signal from the instruction decoder, generates a source I enable output signal and a source 2 enable output signal of a register file designated by the received source 1 and 2 enable input signals, and controls data transmitted to internal output buses of the designated register file in response to the generated source 1 and 2 enable output signals.

3. The SIMD parallel processor according to claim 1, wherein the SIMD operation comprises enabling a register file of a processing unit designated by the instruction and transmitting data of the register file to an input bus of the function unit mounted on the designated processing unit.

4. The SIMD parallel processor according to claim 1, wherein in the SIMD operation, when source 1 and 2 enable output signals of a register file of a processing unit designated by the instruction are maintained at a high level, data of the register file of the designated processing unit are transmitted to the internal output buses of the designated register file.

5. The SIMD parallel processor according to claim 1, wherein the SISD operation comprises disabling a register file of an undesignated processing unit in response to register files selection output signals and a register files selection input signal, enabling a register file of a designated processing unit, and transmitting data of the designated register file to an input bus of the designated processing unit.

6. The SIMD parallel processor according to claim 1, wherein in the SISD operation, when source 1 and 2 enable output signals of a register file of a processing unit undesignated by the instruction are maintained at a low level and source 1 and 2 enable output signals of a register file of a processing unit designated by the instruction are maintained at a high level, data of the register file of the designated processing unit are sequentially transmitted to internal output buses of the register file of the designated processing unit.

7. The SIMD parallel processor according to claim 1, wherein the row operation comprises disabling a register file of an undesignated processing unit arranged in a row direction in response to row operation selection output signals and a row operation enable input signal, enabling a register file of a designated processing unit arranged in the row direction, and transmitting data of the designated register file to an input bus of a function unit mounted on the designated processing unit arranged in the row direction.

8. The SIMD parallel processor according to claim 1, wherein in the row operation, when source 1 and 2 enable output signals of a register file of a processing unit, which is undesignated by the instruction and arranged in a row direction, are maintained at a low level and source 1 and 2 enable output signals of a register file of a designated processing unit arranged in the row direction are maintained at a high level, data of the register file of the designated processing unit arranged in the row direction are transmitted to internal output buses of the register file of the designated processing unit arranged in the row direction.

9. The SIMD parallel processor according to claim 1, wherein the column operation comprises disabling a register file of an undesignated processing unit arranged in a column direction in response to column operation selection output signals and a column operation enable input signal, enabling a register file of a designated processing unit arranged in the column direction, and transmitting data of the designated register file to an input bus of a function unit mounted on the designated processing unit arranged in the column direction.

10. The SIMD parallel processor according to claim 1, wherein in the column operation, when source 1 and 2 enable output signals of a register file of a processing unit, which is undesignated by the instruction and arranged in a column direction, are maintained at a low level and source 1 and 2 enable output signals of a register file of a designated processing unit arranged in the column direction are maintained at a high level, data of the register file of the designated processing unit arranged in the column direction are transmitted to internal output buses of the register file of the designated processing unit arranged in the column direction.
